(19) United States
(12) Patent Application Publication
(10) Pub. No.: US 2024/0386129 A1
(43) Pub. Date: Nov. 21, 2024

(54) Real-Time Personal Health Information Text Masking in Videos

(71) Applicant: EXPLORER SURGICAL CORP., Louisville, CO (US)

(72) Inventors: Eugene Fine, Northbrook, IL (US); Eric Arrington, Sahuarita, AZ (US); Tessa Heydinger, San Diego, CA (US); Alexandr Vovchuk, Pavlodar (KZ); Chingiz Shambetov, Amsterdam (NL); Anatoliy Koldkin, Long Grove, IL (US); Aarsh Patel, Cumming, GA (US)

(73) Assignee: EXPLORER SURGICAL CORP., Louisville, CO (US)

(21) Appl. No.: 18/199,314

(22) Filed: May 18, 2023

(51) Int. Cl. G06F 21/62; G06F 40/232; G06T 5/00; G06V 30/10; G06V 40/16

(52) U.S. Cl. CPC G06F 21/6245; G06F 40/232; G06T 5/70; G06V 30/10; G06V 40/161; G06T 2207/30201

(57) ABSTRACT

The system is configured to perform a process that comprises receiving, by a processor, one or more video feeds from one or more video devices; determining, by the processor using optical character recognition (OCR) in real-time, text that exists in the one or more video feeds; associating, by the processor, geographic coordinates with the text; determining, by the processor using a text analyzer in real-time, a subset of the text that includes personal health information (PHI); redacting, by the processor, at least a portion of the subset of the text that includes PHI based on the geographic coordinates, to create redacted one or more video feeds; and transmitting, by the processor, the redacted one or more video feeds to one or more remote users.

### FIELD

This disclosure generally relates to masking text, and more particularly, to masking Personal Health Information (PHI) text in videos.

### BACKGROUND

Remote learning is becoming more commonly used due to advancements in various technologies. Moreover, the pandemic caused many industries to re-configure how to educate their people, mainly using remote technologies. In some industries, such as healthcare, a push to expand remote learning was even more important due to the desire to limit the number of people in the same room. Remote learning also provides educational and healthcare access to more people that are located in remote areas. Remote learning further promotes travel cost savings and accelerates training on complex surgical techniques, while also providing remote case observation, tele-proctoring and digital case support. By remotely distributing video, the system may accelerate medical device commercialization by synchronizing live case support and data collection. The system may also include comprehensive guides for various roles in the operating room.

In the healthcare world, it is not only important, but in many countries also legally required, to avoid sharing PHI. PHI includes any data that may be used to identify an individual patient. Under the HIPAA act, PHI that is based on a list of 18 identifiers must be treated with special care. Many of the videos used in remote learning may include faces of people, but also text or annotations on monitors and in the videos. The faces of people are often covered with personal protective equipment, so the people cannot be personally identified. However, a need exists to mask, obscure or hide the text that may contain PHI.

### SUMMARY

In various embodiments, with respect to FIG. 3, the system is configured to perform a process that may comprise receiving, by a processor, one or more video feeds from one or more video devices (step 305); determining, by the processor using optical character recognition (OCR) in real-time, text that exists in the one or more video feeds (step 310); associating, by the processor, geographic coordinates with the text (step 315); determining, by the processor using a text analyzer in real-time, a subset of the text that includes personal health information (PHI) (step 320); redacting, by the processor, at least a portion of the subset of the text that includes PHI based on the geographic coordinates, to create redacted one or more video feeds (step 325); and transmitting, by the processor, the redacted one or more video feeds to one or more remote users (step 330).

The one or more video devices may include at least one of a diagnostic device, a surgical device, a video device, a streaming device and an internet source. The method may further comprise transmitting, by the processor, the redacted one or more video feeds to a video conferencing platform. The transmitting the redacted one or more video feeds to the one or more remote users may comprise transmitting the redacted one or more video feeds to a video conferencing platform for viewing by the one or more remote users.

The determining, using OCR, the text that exists in the one or more video feeds may include reviewing one or more frames of the one or more video feeds. The determining, using OCR, the text that exists in the one or more video feeds may include reviewing a subset of one or more frames of the one or more video feeds. The determining the text that exists in the one or more video feeds may include periodically activating the OCR. The determining the text that exists in the one or more video feeds may use OCR operating in a cloud computing system. The text may include at least one of a word or group of words.

The method may further comprise receiving a confidence score about the text including PHI. The determining the subset of the text that may include PHI is based on the PHI having a confidence score above a threshold. The redacting at least a portion of the subset of the text that may include PHI is also based on a frame number of a plurality of frames in the one or more video feeds. The redacting at least a portion of the subset of the text that may include PHI may include further redacting from at least one of a previous frame or a subsequent frame of a plurality of frames in the one or more video feeds. The redacting at least a portion of the subset of the text may include at least one of anonymizing at least a portion of the text, blurring at least a portion of the text, digitally manipulating at least a portion of the text, applying an overlay over at least a portion of the text or pixelating at least a portion of the text.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is an exemplary screenshot of a facial image and text being obscured in a video feed, in accordance with various embodiments.

FIG. 2 is an exemplary screenshot of the PHI text being pixelated in the video feed, in accordance with various embodiments.

FIG. 3 is an exemplary flowchart of the process for obscuring the PHI text, in accordance with various embodiments.

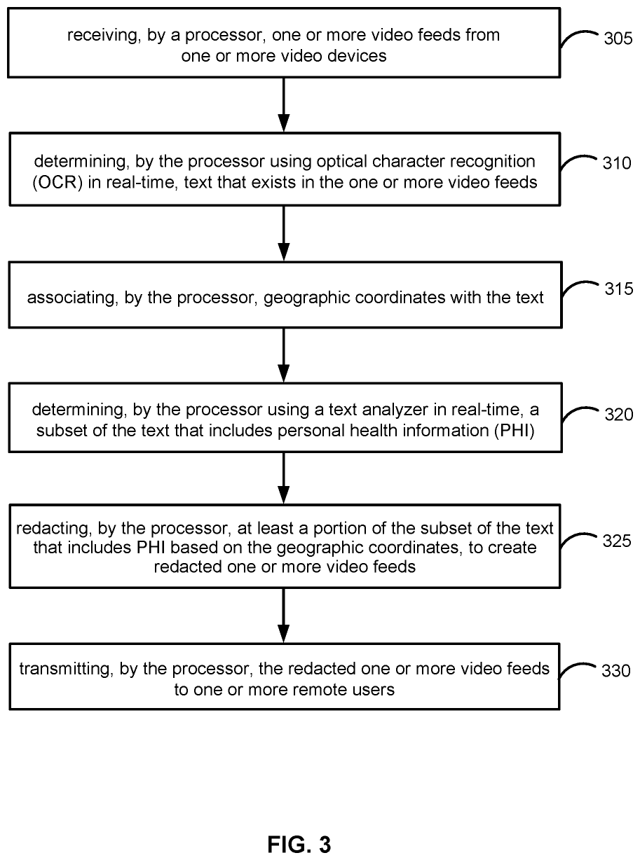

### DETAILED DESCRIPTION

In various embodiments, the system may receive and/or acquire feeds from one or more of the diagnostic devices, surgical devices, video devices or other devices in the operating room. The system may also receive video feeds from other rooms, other facilities and/or from other networks (e.g., streaming video, internet feeds, etc). The videos may be any length of time such as, for example, 30 minutes or 4 hours. One or more computing systems (e.g., iPad, tablet, etc.) may receive one or more of the video feeds. As part of the aggregation of the video feeds, the system may incorporate one or more features of the technology disclosed in U.S. Ser. No. 17/676,446 filed on Feb. 21, 2022 and entitled “Video Input Connector” and U.S. Ser. No. 63/434,014 filed on Dec. 20, 2022 and entitled “Video Aggregator,” both of which are incorporated by reference in their entireties for all purposes. In various embodiments, after the video is processed as set forth herein, the system may directly or indirectly transit and/or stream the video to a remote user. In various embodiments, the video may be transmitted to a video conferencing platform (e.g., Zoom, Microsoft Teams, etc) such that the remote user may access the video through the video conferencing platform. The system may use Meeting Zoom SDK for the video streaming.

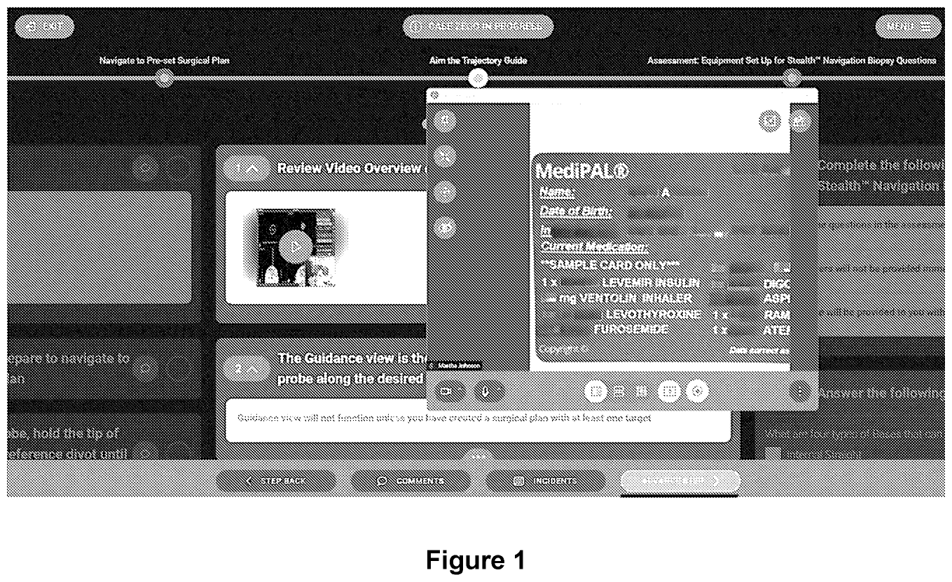

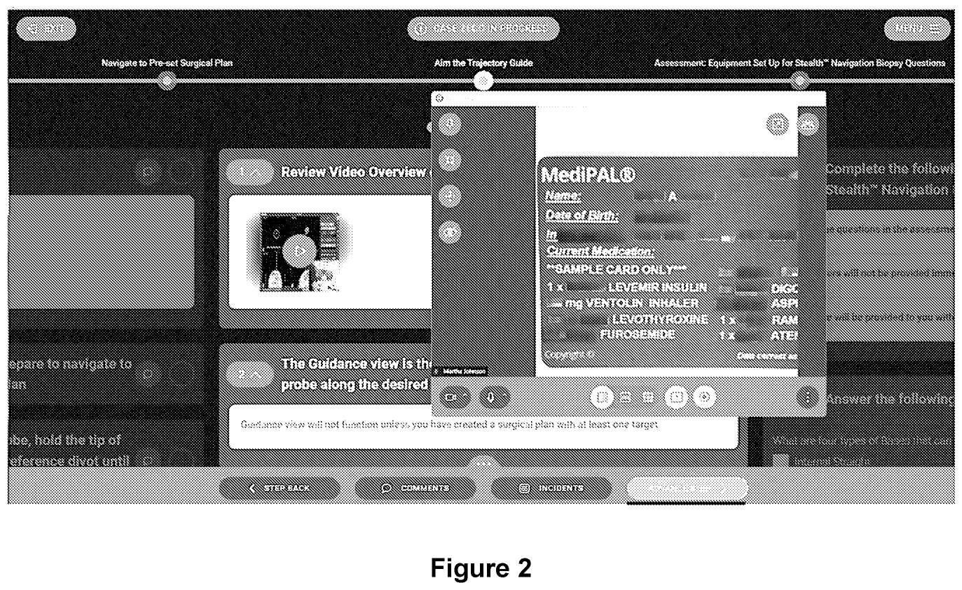

In various embodiments, the system may obscure any faces in the video, as shown in FIGS. 1 and 2. The system may acquire frame data from the video feeds. The system may process the face detection algorithms and obtain the geographic coordinates of the one or more faces. The system may clear any previous coordinate values that may be stored in the memory array. The system may store the geographic coordinates of the faces in the memory array. To obscure the faces, the system may obtain the coordinates of the faces from the memory array. The system may separate each face rectangle into N sub-rectangles (“pixels”). The system may calculate the average value of the color for the sub-rectangle. The system may fill the sub-rectangle with the average color (e.g., the color that is similar to the average value of the color for the sub-rectangle).

In various embodiments, the system may use optical character recognition (OCR) to determine the text that may exist in the video feed, as shown in FIGS. 1 and 2. The system may use the AWS Textract software to conduct the OCR to detect text (e.g., text strings, words, numbers, letters, acronyms, word combinations, etc.). The system may store the array of detected text (e.g., in Redis cache). In various embodiments, the system may also conduct a spell check on the detected text, such that the system replaces or alters some of the detected text with corrected text (e.g., text with corrected spelling). The system may store all of the detected text items. In various embodiments, the system may also associate the geographic (x,y) coordinates of the detected text item with the detected text item. The system may review the video by conducting the OCR analysis on individual frames or any subset of frames. The system may consistently run the OCR analysis over the frames. To save on processing power and battery life, in various embodiments, the system may periodically run the OCR analysis over the frames. For example, the system may run the OCR analysis every 1-3 seconds. Any text will most likely exist over the span of many frames, so missing a few frames may not impact the ability to find the text in the frames. In various embodiments, the OCR analysis may be performed in real-time such that the system actively communicates with the OCR system. In various embodiments, the OCR analysis may be performed locally on a computing system (e.g., iPad, tablet, etc) or conducted in the cloud. Conducing the OCR analysis in the cloud may help to reduce energy use and/or the impact on the battery life of the computing system.

The system may use any suitable facial recognition technology and/or text recognition technology. For example, for facial recognition technology, the system may use Vision Framework Library (iOS), ML Kit Library (Android) and/or OpenCV Library (Windows). For text recognition technology, the system may use ML Kit Library (iOS), ML Kit Library (Android) and/or OpenCV Library (Windows).

In various embodiments, the system may use a text analyzer to determine a subset of the text that may be PHI. In various embodiments, the text analyzer may analyze the detected text in real-time. The system may automatically flag certain items (e.g., text strings, words or phrases) as potential PHI, so that the system may further analyze such items to confirm if PHI exists. For example, the system may flag any items that contain numbers or any items that are not recognized as a known term by the spell check analysis. The system may send the detected words (and/or word phrases) and/or the flagged items to the text analyzer for analysis to determine if any of the detected words are PHI. By submitting groups of words, the text analyzer may be better able to determine if the group of words is a name of a person, other PHI or non-PHI text. The text analyzer may include the Amazon® Comprehend Medical product that may include a DetectPHI operation. The PHI data may include, for example, age, dates, name, phone, fax, email, identifiers, URLs, physical addresses, profession, etc.

In various embodiments, the system may associate and/or save geographic (x,y) coordinates with the detected text item, a subset of the detected text items and/or the PHI items, so the system knows where in the frame the item is located. The system may associate and save just the PHI items with the geographic coordinates. To save memory space, the system may remove the geographic coordinates from the detected text items that are not PHI or not save the geographic coordinates from the detected text items that are not PHI. More particularly, the coordinates of the PHI items may be saved in an array. The array may have a length of N*5, where N is the number of PHI items. The coordinates of the PHI items are stored in the array. The array may operate using the first-in-first-out principle.

In various embodiments, the system may provide confidence scores that indicate the level of confidence in the accuracy of the detected PHI. The user may evaluate these confidence scores and identify the appropriate confidence threshold for the use case. The system may filter out data that does not meet the appropriate confidence score. The subset of the PHI text that is obscured may be the text that meets a certain PHI confidence threshold. When identifying occurrences of PHI, the system may use a low confidence threshold for filtering to capture more potential detected data. The system may also send a subset of the potential PHI (e.g., with a low confidence score) to a human or a more advanced PHI analysis software for review.

In various embodiments, the system may use the x,y coordinates to find the PHI text in the frame. For any frame that the OCR analysis finds text and the DetectPHI operation finds PHI in that text, the system may record a frame number and the x,y coordinates in the frame of that frame number. The system may then obscure all of the PHI text (or at least a subset of the PHI text) in the frame based on the frame number and/or the x,y coordinates, prior to transmitting the video frames to a remote user. More particularly, to obscure the text, the system may acquire the coordinates of the PHI items from the memory array. The system may separate each PHI item rectangle into N sub-rectangles (“pixels”). The system may calculate the average value of the color for the sub-rectangle. The system may fill the sub-rectangle with the average color (e.g., the color that is similar to the average value of the color for the sub-rectangle).

In various embodiments, for the frames where the OCR was periodically not used, the system may use similar x,y coordinates to find the PHI text that may be repeated in prior or subsequent frames, based on the OCR analysis and the x,y coordinates of those particular frames that determined that text existed. The system may then obscure all of the PHI text (or at least a subset of the PHI text) in each of the prior or subsequent frames, prior to transmitting the video frames to a remote user. The extrapolating to the prior or subsequent frames may only be used until a frame is reached where the OCR analysis and the x,y coordinates detection was implemented.

In various embodiments, the system may obscure the PHI text by anonymizing the text and/or using any digital manipulation or overlay. The system may use masking, blurring and/or pixelation to obscure the text. However, the system may use pixelation because pixelation may be a less expensive process, as shown in FIG. 2.

In various embodiments, after the text in the video is obscured, the system may send a signal to an accounting system, procurement system and/or inventory system to allow the user to obtain goods or services from a supplier associated with the video (e.g., supplier of the surgical equipment). The system may generate an authorized purchase message to send to a portal (e.g., a kiosk, a gate, a locker, an area, etc.). The portal may activate a motor, a door and/or a lever to allow the provider access to retrieve a purchased item and/or leave an area with the purchased item. The authorized purchase message may include the purchase order number, purchase order data, transaction number, the timestamp, the currency type, the amount, the transaction code, the transaction type, the description, provider ID, supplier ID, product IDs, a portal ID, and/or the like. The system may then transmit the authorized purchase message to the portal. The portal may verify certain data in the authorized purchase message, and based on the verification, the portal may grant the customer access to the purchased item. In various embodiments, access to the purchased item may include opening a door, lifting a gate, providing access to an area, displaying a product, rotating a platform, dispensing a product and/or causing other mechanical or physical access that allows the user to take the purchased item and/or leave the inventory area.

The system may include remote access to data, standardizing data and allowing remote users to share information in real time. The system may allow users to access data (e.g., videos with text, etc), and receive updated data in real time from other users. The system may store the data (e.g., in a a non-standardized format) in a plurality of storage devices, provide remote access over a network so that users may update the data that was in a non-standardized format (e.g., dependent on the hardware and software platform used by the user) in real time through a GUI, convert the updated data that was input (e.g., by a user) in a non-standardized form to the standardized format, automatically generate a message (e.g., containing the updated data) whenever the updated data is stored and transmit the message to the users over a computer network in real time, so that the user has immediate access to the up-to-date data. The system may allow remote users to share data in real time in a standardized format, regardless of the format (e.g. non-standardized) that the information was input by the user.

The system may include a filtering tool that is remote from the end user and provides customizable filtering features to each end user. The filtering tool may provide customizable filtering by filtering access to the data (e.g., videos with text, etc). The filtering tool may identify data or accounts that communicate with the server and may associate a request for content with the individual account. The system may include a filter on a local computer and a filter on a server. The filtering tool may identify information or accounts that communicate with the server, and associate a request for content with the individual account. The system may include a filter on a local computer and a filter on a server.

The system may store elements from different host websites (e.g., websites providing different videos with text) in a database, then when a user accesses the database, the system may provide a hybrid webpage that merges content or documents from the different host websites. Upon access, the system may merge the content from the various websites and provide a link to the user to access the merged data in the form of an image-based document.

The system may train a neural network when using artificial intelligence or machine learning. The system may include an expanded data set of past data to train the neural network. The expanded training set may be developed by applying mathematical algorithms to the acquired set of data. The neural network is then trained with the expanded data set using a machine learning algorithm that uses a mathematical function to adjust certain weighting. The system may also use an iterative training algorithm to re-train with additional data.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not for purposes of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. An individual component may be comprised of two or more smaller components that may provide a similar functionality as the individual component. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. For example, the description or claims may refer to a processor for convenience, but the invention and claim scope contemplates that the processor may be multiple processors. The multiple processors may handle separate tasks or combine to handle certain tasks. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The system may allow users to access data, and receive updated data in real time from other users. The system may store the data (e.g., in a standardized format) in a plurality of storage devices, provide remote access over a network so that users may update the data in a non-standardized format (e.g., dependent on the hardware and software platform used by the user) in real time through a GUI, convert the updated data that was input (e.g., by a user) in a non-standardized form to the standardized format, automatically generate a message (e.g., containing the updated data) whenever the updated data is stored and transmit the message to the users over a computer network in real time, so that the user has immediate access to the up-to-date data. The system allows remote users to share data in real time in a standardized format, regardless of the format (e.g. non-standardized) that the information was input by the user. The system may also include a filtering tool that is remote from the end user and provides customizable filtering features to each end user. The filtering tool may provide customizable filtering by filtering access to the data. The filtering tool may identify data or accounts that communicate with the server and may associate a request for content with the individual account. The system may include a filter on a local computer and a filter on a server.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodically, randomly, once, more than once, or in response to a suitable request or action. Any of the information may be distributed and/or accessed via a software enabled link, wherein the link may be sent via an email, text, post, social network input, and/or any other method.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112 (f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements, but also to the various system components as described herein. It should be understood that, although exemplary embodiments are illustrated in the figures and described herein, the principles of the present disclosure may be implemented using any number of techniques, whether currently known or not. The present disclosure should in no way be limited to the exemplary implementations and techniques illustrated in the drawings and described below. Unless otherwise specifically noted, articles depicted in the drawings are not necessarily drawn to scale.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY DISC®, optical storage devices, magnetic storage devices, and/or the like.

In various embodiments, components, modules, and/or engines of system 100 may be implemented as desktop applications, micro-applications or micro-apps. Micro-apps may be typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components may be contemplated. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQ™ (formerly MQSeries) by IBM®, Inc. (Armonk, NY) is an example of a commercially available middleware product. An Enterprise Service Bus (“ESB”) application is another example of middleware.

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER R database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies. The ALEXA® system, GOOGLE HOME® system, and HOMEPOD® system, may each provide cloud-based voice activation services that can assist with tasks, entertainment, general information, and more. All the ALEXA® devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME®, and HOMEPOD® systems may also allow the user to access information about eligible transaction accounts linked to an online account across all digital assistant-enabled devices.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices. The AI or ML may store data in a decision tree in a novel way.

In various embodiments, the embodiments are directed toward one or more computer systems capable of carrying out the functionalities described herein. The computer system includes one or more processors. The processor is connected to a communication infrastructure (e.g., a communications bus, cross-over bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a program cartridge and cartridge interface (such as that found in video game devices), a removable memory chip (such as an erasable programmable read only memory (EPROM), programmable read only memory (PROM)) and associated socket, or other removable storage units and interfaces, which allow software and data to be transferred from the removable storage unit to a computer system.

The terms “computer program medium,” “computer usable medium,” and “computer readable medium” are used to generally refer to media such as removable storage drive and a hard disk installed in hard disk drive. These computer program products provide software to a computer system.

The computer system may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16-bit integers.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through various data association techniques. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with various embodiments, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet may be contemplated.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over technology by using a decentralized database and improved processing environments. In particular, the blockchain implementation improves computer performance by, for example, leveraging decentralized resources (e.g., lower latency). The distributed computational resources improves computer performance by, for example, reducing processing times. Furthermore, the distributed computational resources improves computer performance by improving security using, for example, cryptographic protocols.

1. A method comprising:
receiving, by a processor, one or more video feeds from one or more video devices;
determining, by the processor using optical character recognition (OCR) in real-time, text that exists in the one or more video feeds;
associating, by the processor, geographic coordinates with the text;
determining, by the processor using a text analyzer in real-time, a subset of the text that includes personal health information (PHI);
redacting, by the processor, at least a portion of the subset of the text that includes PHI based on the geographic coordinates, to create redacted one or more video feeds; and
transmitting, by the processor, the redacted one or more video feeds to one or more remote users.

2. The method of claim 1, wherein the one or more video devices include at least one of a diagnostic device, a surgical device, a video device, a streaming device and an internet source.

3. The method of claim 1, further comprising transmitting, by the processor, the redacted one or more video feeds to a video conferencing platform.

4. The method of claim 1, wherein the transmitting the redacted one or more video feeds to the one or more remote users comprises transmitting the redacted one or more video feeds to a video conferencing platform for viewing by the one or more remote users.

5. The method of claim 1, wherein the determining, using OCR, the text that exists in the one or more video feeds includes reviewing one or more frames of the one or more video feeds.

6. The method of claim 1, wherein the determining, using OCR, the text that exists in the one or more video feeds includes reviewing a subset of one or more frames of the one or more video feeds.

7. The method of claim 1, wherein the determining the text that exists in the one or more video feeds includes periodically activating the OCR.

8. The method of claim 1, wherein the determining the text that exists in the one or more video feeds uses OCR operating in a cloud computing system.

9. The method of claim 1, wherein the text includes at least one of a word or group of words.

10. The method of claim 1, further comprising receiving, by the processor, a confidence score about the text including PHI.

11. The method of claim 1, wherein the determining the subset of the text that includes PHI is based on the PHI having a confidence score above a threshold.

12. The method of claim 1, wherein the redacting at least a portion of the subset of the text that includes PHI is also based on a frame number of a plurality of frames in the one or more video feeds.

13. The method of claim 1, wherein the redacting at least a portion of the subset of the text that includes PHI includes further redacting from at least one of a previous frame or a subsequent frame of a plurality of frames in the one or more video feeds.

14. The method of claim 1, wherein the redacting at least a portion of the subset of the text includes at least one of anonymizing at least a portion of the text, blurring at least a portion of the text, digitally manipulating at least a portion of the text, applying an overlay over at least a portion of the text or pixelating at least a portion of the text.

15. The method of claim 1, further comprising conducting, by the processor, spell check on the text.

16. The method of claim 1, further comprising:
determining, by the processor using a facial detection algorithm, a face that exists in the one or more video feeds;
associating, by the processor, geographic coordinates with the face; and
redacting, by the processor, at least a portion of the face based on the geographic coordinates, to create a redacted face.

17. The method of claim 1, further comprising associating, by the processor, the subset of the text that includes PHI with geographic coordinates.

18. An article of manufacture including a non-transitory, tangible computer readable storage medium having instructions stored thereon that, in response to execution by a processor, cause the processor to perform operations comprising:
receiving, by the processor, one or more video feeds from one or more video devices;
determining, by the processor using optical character recognition (OCR) in real-time, text that exists in the one or more video feeds;
associating, by the processor, geographic coordinates with the text;
determining, by the processor using a text analyzer in real-time, a subset of the text that includes personal health information (PHI);
redacting, by the processor, at least a portion of the subset of the text that includes PHI based on the geographic coordinates, to create redacted one or more video feeds; and
transmitting, by the processor, the redacted one or more video feeds to one or more remote users.

19. A system comprising:
a processor; and
a tangible, non-transitory memory configured to communicate with the processor,
the tangible, non-transitory memory having instructions stored thereon that, in response to execution by the processor, cause the processor to perform operations comprising:
receiving, by the processor, one or more video feeds from one or more video devices;
determining, by the processor using optical character recognition (OCR) in real-time, text that exists in the one or more video feeds;
associating, by the processor, geographic coordinates with the text;
determining, by the processor using a text analyzer in real-time, a subset of the text that includes personal health information (PHI);
redacting, by the processor, at least a portion of the subset of the text that includes PHI based on the geographic coordinates, to create redacted one or more video feeds; and
transmitting, by the processor, the redacted one or more video feeds to one or more remote users.
